(19) United States
(12) Patent Application Publication
(10) Pub. No.: US 2011/0141740 A1
(43) Pub. Date: Jun. 16, 2011

(54) CUSTOMIZABLE TREE STAND

(75) Inventors: Mary Scollan, Oakland Park, FL (US); Minerva Panico, Hollywood, FL (US); Daniel W. Forbes, Pembroke Pines, FL (US)

(73) Assignee: ATICO INTERNATIONAL USA, INC., Fort Lauderdale, FL (US)

(21) Appl. No.: 12/636,300

(22) Filed: Dec. 11, 2009

(51) Int. Cl. F21S 4/00; A47G 33/12; A01G 27/06

(52) U.S. Cl. 362/249.18; 248/523; 47/40.5

(57) ABSTRACT

The present invention comprises a stand for supporting an ornamental object which provides one or more means for appearance customization. In particular, the present invention provides a tree stand with customizable elements flanking the tree-support element(s).

### FIELD OF THE INVENTION

The present invention comprises a stand for supporting an ornamental object which provides one or more means for appearance customization. In particular, the present invention provides a tree stand with customizable elements flanking the tree-support element(s).

### BACKGROUND

During the Christmas season, it is commonplace for individuals and families, particularly of the Christian faith, to adorn their living spaces and/or work places with one or more trees decorated with various lights and ornaments. Artificial trees or a “live” or cut tree are used for this purpose. The Christmas tree, whether artificial or live, requires support to maintain the tree upright and prevent it from tipping over. Trees typically require a stand having a base and, in the case of a cut tree, a water basin or reservoir for providing water essential for maintaining tree freshness, to reduce needle shedding, and for preventing the cut tree from becoming a fire hazard. Trees are not uniform and symmetrical in shape. To support the tree against tipping, the base of the stand needs to be broad enough to provide stability when the trunk of the tree is mounted within. The stand may include one or more threaded screws, or other elements, which stabilize the tree trunk when the trunk's lower end is positioned into the stand.

### SUMMARY OF THE INVENTION

The present invention provides a tree stand comprising a tree-receiving element, tree-supporting element, and customizable ornamentation element. In some embodiments, the customizable ornamentation element comprises one or more ornamental insert panels and one or more insert recesses. In some embodiments, the ornamental insert panels are configured to fit within the insert recesses. In some embodiments, the ornamental insert panels are outwardly displayed when inserted into the insert recesses. In some embodiments, the customizable ornamentation element comprises 4 insert recesses. In some embodiments, the insert panels comprise an image, design, or message for outward display. In some embodiments, the customizable ornamentation element comprises an illumination means. In some embodiments, the light from the illumination means is viewed through one or more of the ornamental insert panels inserted into one or more of the insert recesses. In some embodiments, the light from the illumination means illuminates an image, design, or message on one or more of the ornamental insert recesses. In some embodiments, the ornamental insert panel comprises one or more translucent regions and one or more opaque regions. In some embodiments, the translucent regions and the opaque regions are configured to form an image, design, or message. In some embodiments, the tree receiving element further comprises a water basin. In some embodiments, the tree receiving element and the customizable ornamentation element comprise a single unit. In some embodiments, the tree receiving element and said customizable ornamentation element comprise distinct elements. In some embodiments, the customizable ornamentation element resides on the periphery of the tree stand. In some embodiments, the customizable ornamentation element comprises a single display unit to be viewed from multiple directions. In some embodiments, the single display unit comprises one or more images, designs, or messages for outward display. In some embodiments, the single display unit comprises one or more translucent regions. In some embodiments, the said single display unit comprises one or more opaque regions. In some embodiments, one or more opaque regions and one or more translucent regions are configured to form an image, design, or message. In some embodiments, the light from the illumination element is configured to illuminate the single display unit. In some embodiments, a customizable ornamentation element comprises an electronic display. In some embodiments, a customizable ornamentation element comprises one or more movable parts. In some embodiments, a customizable ornamentation element rotates about an axis. In some embodiments, a customizable ornamentation element comprises a box-shape. In some embodiments, a customizable ornamentation element comprises a cylinder-shape.

### BRIEF DESCRIPTION OF THE FIGURES

The following drawings form part of the present specification and are included to further illustrate aspects of the present invention. The drawings highlight exemplary embodiments of the present invention, but should not be viewed as limiting the scope of the invention. The invention may be better understood by reference to the drawings in combination with the detailed description of the specific embodiments presented herein.

FIG. 1 shows an exemplary customizable ornamentation element. The customizable ornamentation element comprises 4 insert recesses around its periphery which are configured to accept a variety of ornamentation insert panels.

FIG. 2 shows an exemplary customizable ornamentation element with ornamental insert panels inserted into the insert recesses. The insert panels are outwardly displayed from the customizable ornamentation element.

FIG. 3 shows and exemplary tree stand of the present invention.

### DETAILED DESCRIPTION OF THE INVENTION

The present invention generally comprises a stand for supporting an object which provides one or more means for appearance customization. In particular, the present invention provides a tree stand with one or more customizable ornamentation elements flanking the tree-support element(s).

In some embodiments, the invention is a stand for any ornamental object (e.g. tree, Christmas tree, holiday décor, statue, etc.). Although generally referred to as a “tree,” embodiments described herein also apply to other ornamental objects used with a stand of the present invention. The present invention commonly provides a stand for a tree (e.g. coniferous tree), most typically a Christmas tree. As used herein, the terms “base,” “tree base,” “Christmas tree base,” “stand,” “tree stand,” and “Christmas tree stand” are used interchangeably to refer to the invention in its broadest form. A Christmas tree supported by a stand of the present invention can be natural or artificial.

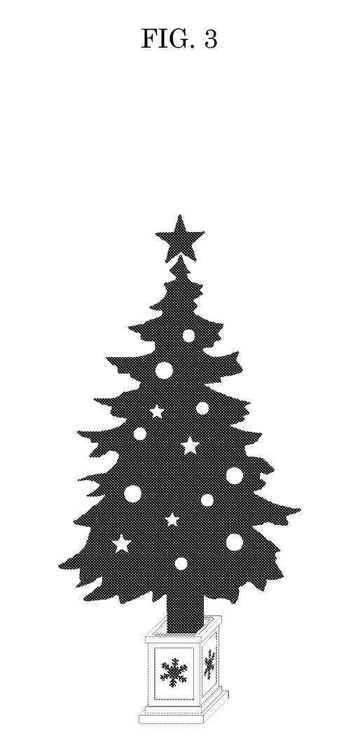

In some embodiments, the present invention comprises a tree stand which comprises one or more customizable ornamentation elements (SEE FIG. 3), and one or more of a tree receiving element, tree support element, stand support element, and water basin. In some embodiments, the present invention comprises a tree receiving element and one or more customizable ornamentation elements. In some embodiments, the present invention comprises a tree receiving element, tree support element, and one or more customizable ornamentation elements. In some embodiments, a stand comprises a receiving element, one or more tree-support elements, one or more stand-support elements, and one or more customizable ornamentation elements. In some embodiments, the receiving element comprises a central portion which accepts the tree trunk. In some embodiments, the receiving element also houses the tree-support element(s). The receiving element may optionally provide a water basin. In some embodiments, the tree-support elements reside within the central portion of the stand and are blocked from plain view by the periphery of the stand, particularly when a tree is inserted into the stand. In some embodiments, a stand comprises one or more stand-support elements (e.g. legs, feet, bottom) which provide support for the stand when a tree is in place. In some embodiments, one or more customizable ornamentation elements reside on the periphery of the stand and are viewable in the presence or absence of a tree within the stand.

In some embodiments, any suitable tree-support elements find use with the present invention. Suitable tree-support elements include a plurality of screws (e.g. 2, 3, 4, etc.) which engage the truck of the tree around its circumference; a single spike, screw, or cylinder which engages the trunk through a hole (pre-drilled or created by the support element) in the bottom end of the trunk; a circular band which wraps around the circumference of the trunk; a clamp or strap mechanism; or any suitable support mechanism or combination of support mechanisms (e.g. one or more screws and one or more clamps). In some embodiments, the tree-support element resides within the receiving element. In some embodiments, the tree-support element is directly connected to the receiving element and/or stand-support element(s). In some embodiments, the tree-support element is indirectly connected to the stand-support element(s).

In some embodiments, the receiving element and the tree-support element comprise a single unit. In some embodiments, the receiving element and the tree-support element comprise separate units (attached or unattached). In some embodiments, the receiving element comprises a bowl- or cylinder-shaped vessel which receives the trunk of the tree through a trunk-receiving opening in the receiving element. In some embodiments, the end of the receiving element opposite the trunk-receiving opening comprises another opening, such that the trunk can be placed through the receiving element. In some embodiments, the end of the receiving element opposite the trunk-receiving opening is sealed such that the trunk cannot extend beyond the lower end of the receiving element. In some embodiments, the receiving element comprises a single open end to receive the tree, but is otherwise sealed. In some embodiments, the receiving element comprises a vessel or basin configured to receive and hold water or other fluids. In some embodiments, the receiving element is configured to hold water or other fluids adjacent to and/or surrounding the bottom of the tree trunk (e.g. to nourish the tree).

In some embodiments, the stand is supported by one or more stand-support elements (e.g. 1, 2, 3, 4 . . . 10, etc.). In some embodiments, stand-support elements are configured to maintain the stand in its intended conformation (e.g. right-side up). In some embodiments, stand-support elements are configured to maintain the stand and a tree in the correct conformation (e.g. vertical). In some embodiments, placement of a tree into the receiving elements places increased forces onto the tree stand (e.g. forces (e.g. torque) to tip the tree and tree stand). In some embodiments, a tree contained within the receiving elements places additional torque onto the tree stand. In some embodiments, stand-support elements comprise the bottom of the stand. In some embodiments, the bottom of the stand rests upon a surface (e.g. ground, floor, table, etc.) and provides support (e.g. sufficient support) for the tree stand and a tree contained therein. In some embodiments, the bottom of the stand is weighted to provide additional support for the stand and/or tree. In some embodiments, a stand of the present invention comprises feet or pads (e.g. attached to, or located on the bottom of the stand) which provide support for the stand and/or tree. In some embodiments, feet or pads provide a means (e.g. adhesive, clamp, screw, etc.) of attaching a stand to a surface (e.g. floor, ground, table, etc.). In some embodiments, a stand of the present invention comprises legs or supports (e.g. 2, 3, 4, 5, 6 . . . 10, etc.) which extend outward and/or downward from the receiving element and provide additional support the stand and/or tree. In some embodiments, supports and/or legs are attached to the receiving element at the bottom, top, and/or anywhere on the receiving element. In some embodiments, legs and/or supports are attached to the tree-support element(s).

Exemplary receiving elements, tree-support elements, and/or stand support elements which may find use in the present invention are described in U.S. Pat. No. 7,597,304; U.S. Pat. No. 6,612,071; U.S. Pat. No. 6,142,441; U.S. Pat. No. 5,797,579; U.S. Pat. No. 5,732,926; U.S. Pat. No. 5,577,701; U.S. Pat. No. 5,362,024; U.S. Pat. No. 5,337,990; U.S. Pat. No. 5,249,772; U.S. Pat. No. 5,114,113; U.S. Pat. No. 4,825,586; U.S. Pat. No. 4,699,347; U.S. Pat. No. 4,496,129; U.S. Pat. No. 4,429,846; U.S. Pat. No. 4,261,138; herein incorporated by reference in their entireties.

The present invention provides a tree stand comprising one or more customizable-ornamentation elements. The customizable-ornamentation element provides a device, means, or mechanism to decorate, personalize, customize, and/or enhance the appearance of the tree stand. In some embodiments, the customizable-ornamentation element provides a means for displaying personal, pre-set, customized, and/or decorative elements on the exterior of the tree stand. In some embodiments, the customizable ornamentation element comprises the receiving element. In some embodiments, the receiving element is decorated or adorned in any manner described herein. In some embodiments, the receiving element is constructed of any suitable materials described herein (e.g. metal, glass, plastic, wood, polymer, fabric, etc.). In some embodiments, the receiving element is translucent, transparent, and/or provides incomplete coverage, and light is allowed to pass from within the receiving element. In some embodiments, a customizable ornamentation elements comprises a light source, and a receiving element configured to allow light to pass through to craet and image or design.

In some embodiments, one or more customizable panel elements (e.g. 1, 2, 3, 4, 5, 6, 7, 8, 9, 10, 11, 12, etc.) are displayed around the periphery of the tree stand. In some embodiments, panel elements are removable and replaceable. In some embodiments, panel elements are selected by the user to display desired and/or customized theme(s), design(s) and/or message(s). In some embodiments, a customizable ornamentation element comprises one or more ornamental insert panels (e.g. 1, 2, 3, 4, 5, 6, 7, 8, 9, 10, 11, 12, etc.) and one or more insert recesses (e.g. 1, 2, 3, 4, 5, 6, 7, 8, 9, 10, 11, 12, etc.). In some embodiments, a customizable ornamentation element comprises one insert recess and an ornamental insert panel configured to fit within the insert recess. In some embodiments, a stand may comprise more than one customizable ornamentation elements around the periphery of the stand. In some embodiments, an ornamental insert panel is configured (e.g. sized and shaped) for insertion into a corresponding insert recess. In some embodiments, an ornamental insert panel is visibly displayed on the exterior of a tree stand when inserted into the insert recess. In some embodiments, inserted ornamental insert panels are observable from the exterior of the tree, in the presence or absence of a tree in the stand.

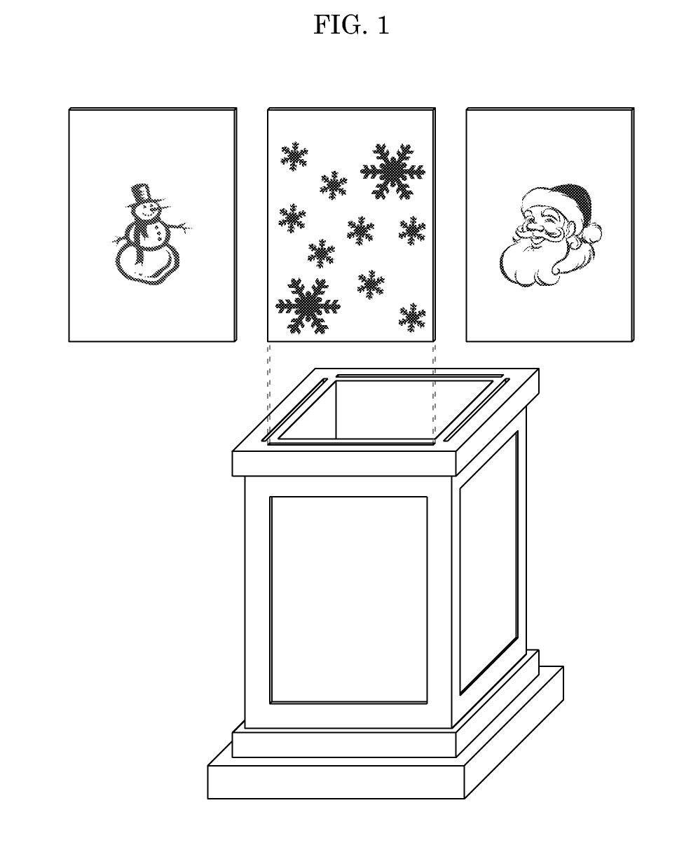

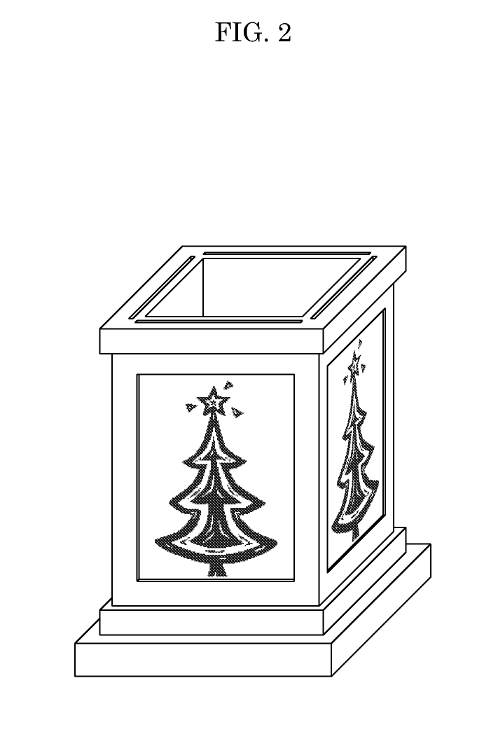

In some embodiments, a tree stand comprises a customizable-ornamentation element which surrounds the receiving element. In some embodiments, the customizable-ornamentation element and the receiving element comprise a single unit. In some embodiments, a customizable-ornamentation element surrounds the trunk of a tree that is inserted into the receiving element. In some embodiments, one or more insert recesses surround the receiving element and/or a tree within the stand (SEE FIG. 1). In some embodiments, each side of the customizable-ornamentation element comprises one or more (e.g. 1, 2, 3, etc.) insert recesses. In some embodiments, each side of the customizable-ornamentation element comprises one insert recess. In some embodiments, a receiving element comprises one or more customizable-ornamentation elements. In some embodiments, each side of a receiving element comprises one or more customizable-ornamentation elements. In some embodiments, each side of a receiving element comprises one insert recess configured to receive one ornamental insert panel. In some embodiments, each side of a receiving element comprises one or more insert recesses configured to receive one or more ornamental insert panels. In some embodiments, each side of a customizable-ornamentation element (e.g. 3 sides, 4 sides, 5 sides, 6 sides, 7 sides, 8 sides, etc.) comprises one insert recess configured to receive one ornamental insert panel (SEE FIGS. 1 and 2). In some embodiments, each side of a receiving element (e.g. 3 sides, 4 sides, 5 sides, 6 sides, 7 sides, 8 sides, etc.) comprises one insert recess configured to receive one ornamental insert panel. In some embodiments, a customizable-ornamentation element surrounds a receiving element. In some embodiments, a customizable-ornamentation element comprises the outer circumference of a receiving element. A receiving element and a customizable-ornamentation element may comprises a single unit or separate elements. In some embodiments, the cross-section of a customizable-ornamentation element comprises a polygon comprising one side per receiving element (e.g. 3 receiving elements for a triangle; 4 receiving elements form a square; 5 receiving elements form a pentagon; 6 receiving elements form a hexagon, 7 receiving elements form a heptagon, 8 receiving elements form an octagon, etc.) (SEE FIG. 1). In some embodiments, a customizable ornamentation element comprises any suitable shape (e.g. box, cylinder, sphere, sphere-like, ovular, globular, etc.)

In some embodiments, the present invention comprises a customizable ornamentation element configured for use with a separate tree stand. A tree stand is placed within the center of the ornamentation element of the present invention to provide visual appeal to the tree stand. A customizable ornamentation element for use with a separate tree stand may comprises any of the features or characteristics of customizable tree stand ornamentation elements described herein.

In some embodiments, the panel elements comprise customized ornamental insert panels (SEE FIG. 1). In some embodiments, the ornamental insert panel comprises a decorative insert. In some embodiments an ornamental insert panel comprises an image, design, item, decoration, etc. to provide decoration to a tree stand. In some embodiments the decoration could be a holiday themed display (e.g. Christmas (e.g. Santa, holly, sleigh, cross, Jesus, Christmas tree, etc.), Hanukkah (e.g. Star of David, dradle, etc.), Easter, Independence Day, birthdays, etc.), a personalized image, a nature scene, customized décor, miniature sports equipment (e.g. baseball bat, golf club, bowling ball, etc.), animal (e.g. fish, dog, cat, etc), company logo, etc. In some embodiments, the decoration may be personalized for a specific individual or customer (e.g. design-your-own tree stand decoration). In some embodiments, the decoration could be any image, design, item, or decoration that one might choose to adorn a tree stand. In some embodiments, the ornamental insert panel comprises a label. In some embodiments, the label comprises letters, numerals, symbols or other indicia. In some embodiments, the label provides a general message which can be descriptive (e.g. “Family”, “Friends”, “Christmans”, “Noel”, “Home”, “Holiday”, “Dad's tree”, “Love”, “Jesus”, “Winter”, “Our House”, “Home Sweet Home”, etc.). In some embodiments, the label provides a specific personalized message (e.g. “The Johnson's Tree”, “Christmas with Ed”, “Monson X-Mas”, “Crystal Lake”, etc.). In some embodiments, the label provides a personalized or customized appearance. In some embodiments, the label provides symbols other than letter and numbers (e.g. “♡Love♡”, “ [symbol] Sing”, “ΔΘ”, “♡”, etc.). In some embodiments, the label may be in any font, script, language, size, etc. In some embodiments, the ornamental insert panel may comprise both a label and decoration. In some embodiments, the label can comprise any desired message.

In some embodiments, an ornamental insert panel comprises opaque, non-transparent, non-translucent panel which displays any image or message. In some embodiments, the image or message is outwardly displayed from within an insert recess of a customizable-ornamentation element. In some embodiments, an ornamental insert panel is partially translucent. In some embodiments, one or more portions of an ornamental insert panel are translucent. In some embodiments, an insert pant only partially covers the opening of an insert recess. In some embodiments, a design or message is created by the contrast between the covered and uncovered portions of the insert recess and/or panel. In some embodiments, a design or message is created by the contrast between the opaque and translucent regions of the insert recess or panel. In some embodiments, a design is die-cut into an insert panel or ornamentation element. In some embodiments, a design is printed onto an insert panel or ornamentation element. In some embodiments, light passes through an ornamental insert panel to produce an illuminated image or message. In some embodiments, a customizable-ornamentation element comprises a light source to project light through one or more ornamental insert panel to produce an illuminated image. In some embodiments, a stand comprises one or more light sources and/or illumination elements (e.g. light bulb, LED, halogen bulb, etc). In some embodiments, a stand comprises one or more lighted or illuminated customizable ornamentation elements. In some embodiments, a light source provides light to illuminate one or more ornamental insert panels in one or more insert recesses. In some embodiments, one or more light sources are configured to rotate or move. In some embodiments, light sources may comprises one or more colors (e.g. red, green, black light, yellow, white). In some embodiments, light sources may change or alternate colors. In some embodiments, an ornamentation element may comprise one or more different colors, and may change or alternate colors in any suitable pattern, rhythm, rate, and/or time-scale.

In some embodiments, insert panels may comprise any suitable materials including, but not limited to one or more metals (e.g. aluminum, chromium, cobalt, copper, gold, iron, nickel, platinum, silver, tin, titanium, zinc, etc.), alloys (e.g. steel, stainless steel, cast iron, bronze, solder, etc.), plastics or polymers (e.g. Bakelite, neoprene, nylon, PVC, thermoplastic polyurethane, polystyrene, polyacrylonitrile, PVB, silicone, rubber, polyamide, synthetic rubber, vulcanized rubber, acrylic, polyethylene, polypropylene, etc.), natural materials, woods, synthetic materials, glass, fabrics (e.g. cotton, wool, polyester, etc.), etc. In some embodiments, insert panels may comprise any color and/or combination of colors. In some embodiments, a customizable ornamentation element and/or one or more insert panels may comprise a digital image, video image, one or more light sources (e.g LEDs), etc. In some embodiments, the customizable ornamentation element is configured to display pre-set or user-select images, photos, or video. In some embodiments, a customizable ornamentation element comprises an electronic display. In some embodiments, a customizable ornamentation element comprises one or more movable parts. In some embodiments, a customizable ornamentation element rotates around a central axis (e.g. tree). In some embodiments, the display and/or outward appearance of a customizable ornamentation element changes as the element moves and/or rotates.

In some embodiments, the present invention provides a kit comprising one or more of ornamental insert panels, one or more ornamentation elements, and one or more tree stands. In some embodiments, a kit comprises a tree stand configured with an ornamentation element and multiple ornamental panel inserts. In some embodiments, a kit provides a set of panels for insertion into a separate ornamentation element. In some embodiments a kit provides panels which are custom ordered to display images selected by a customer. In some embodiments, a kit provides a set of panels with identical designs for insertion into a customizable ornamentation element. In some embodiments, a kit provides a set of panels with different images, allowing a user to customize the appearance of a tree stand.

In some embodiments, ornamental insert panels are customizable by a user. In some embodiments, panels are configured to accept images and/or designs made by a user (e.g. printed from a computer or hand drawn). In some embodiments, a panel is configured for a user to create an image or design by removing (e.g. cutting out) segments of the panel. In some embodiments, panels are provided in user-customizable kits.

What is claimed is:

1. A tree stand comprising a tree-receiving element, tree-supporting element, and customizable ornamentation element.

2. The tree stand of claim 1, wherein said customizable ornamentation element comprises one or more ornamental insert panels and one or more insert recesses.

3. The tree stand of claim 2, wherein said ornamental insert panels are configured to fit within said insert recesses, and wherein said ornamental insert panels are outwardly displayed when inserted into said insert recesses.

4. The tree stand of claim 3, wherein said customizable ornamentation element comprises 4 insert recesses.

5. The tree stand of claim 3, wherein said insert panels comprise an image, design, or message for outward display.

6. The tree stand of claim 1, wherein said customizable ornamentation element comprises an illumination means.

7. The tree stand of claim 6, wherein light from said illumination means is viewed through one or more of said ornamental insert panels inserted into one or more of said insert recesses.

8. The tree stand of claim 7, wherein said light from said illumination means illuminates an image, design, or message on one or more of said ornamental insert recesses.

9. The tree stand of claim 8, wherein said ornamental insert panel comprises a one or more translucent regions and one or more opaque regions.

10. The tree stand of claim 9, wherein said translucent regions and said opaque regions are configured to form said image, design, or message.

11. The tree stand of claim 1, wherein said tree receiving element further comprises a water basin.

12. The tree stand of claim 1, wherein said tree receiving element and said customizable ornamentation element comprise a single unit.

13. The tree stand of claim 1, wherein said tree receiving element and said customizable ornamentation element comprise distinct elements.

14. The tree stand of claim 1, wherein said customizable ornamentation element resides on the periphery of said tree stand.

15. The tree stand of claim 14, wherein said customizable ornamentation element comprises a single display unit to be viewed from multiple directions.

16. The tree stand of claim 15, wherein single display unit comprises one or more images, designs, or messages for outward display.

17. The tree stand of claim 16, wherein said single display unit comprises one or more translucent regions.

18. The tree stand of claim 17, wherein said single display unit comprises one or more opaque regions.

19. The tree stand of claim 18, wherein said one or more opaque regions and one or more translucent regions are configured to form said image, design, or message.

20. The tree stand of claim 19, wherein said light from said illumination element is configured to illuminate said single display unit.
